(19) United States
(12) Patent Application Publication
(10) Pub. No.: US 2019/0004818 A1
(43) Pub. Date: Jan. 3, 2019

(54) Method of UEFI Shell for Supporting Power Saving Mode and Computer System thereof

(71) Applicant: American Megatrends Inc., Norcross, GA (US)

(72) Inventor: Chao-Ming Wu, Taipei (TW)

(21) Appl. No.: 15/637,070

(22) Filed: Jun. 29, 2017

(51) Int. Cl. G06F 9/44; G06F 1/32

(52) U.S. Cl. CPC G06F 9/4418; G06F 1/3231; G06F 1/3287

(57) ABSTRACT

A method of computer processor execution of an UEFI shell in a computer system for entering into a power saving mode, the UEFI shell is located in a memory, the memory is connected to the processor, the method comprising: executing, by the processor, the UEFI shell; when executing the UEFI shell: initiating a call to a power saving library; retrieving corresponding power configuration data; retrieving and storing hardware registers data to memory; and enabling system control interrupt and configuring power-saving control registers with the power configuration data.

### BACKGROUND

### 1. Technical Field

The present disclosure generally relates to a method of a UEFI Shell and computer system thereof; particularly, the present disclosure relates to a method and computer system for executing an UEFI Shell supporting entering and recovery from a power saving mode.

### 2. Description of the Related Art

Traditionally, computer systems may boot to an operating system. The boot up of the operating system is typically handled by a low level instruction code that is used as an intermediary between the hardware components of the computer system and the operating software and other high level software executing on the computing system. This low level instruction code is often known as the Basic Input/Output System (“BIOS”) firmware and provides a set of software routines that allow high level software to interact with the hardware components of the computing system. The firmware performs routines for conducting Power-On Self Test (“POST”) each time the computer system is powered on in order to test and initiate all hardware components in the computer system before handing off control to the operating system. These hardware components may include the system main memory, disk drives, and keyboards.

However, as technology has progressed with many devices such as peripheral devices advancing towards being wireless or cordless, boot up firmwares based on the traditional BIOS standard, which was originally designed for personal computers of International Business Machine Corporation (IBM), have become a point of restriction or limitation as to what the boot up firmware may control with respect to hardware and subsequently what hardware the Operating System may control. As new hardware and software technologies were being developed, this source of restriction became a major obstacle in the hardware-software interaction. As a result, a new standard of BIOS firmware has been proposed and widely adopted by many major industry leaders. This new standard is called the Unified Extensible Firmware Interface (UEFI).

With the adoption of UEFI standards, BIOS companies were able to produce UEFI firmware for computer systems, while companies producing Operating Systems were able to take advantage of the services these UEFI firmware provided by producing UEFI compliant Operating Systems.

However, during the manufacturing stage, computer system manufacturers may need to perform diagnostics on the computer system to ensure their quality control is up to par and within reasonable failure margins before delivering to their customers. A common procedure is to test the computer system prior to any Operating System being installed. However, with hundreds and thousands of computer systems needing testing, the power required to keep the computer systems powered on while they wait before being tested is a source of concern. In other cases, when performing time consuming diagnostic testing on the computer systems, diagnostic engineers may need to occasionally leave the workspace. In these circumstances, the diagnostic work left running would also incur unnecessary power waste. Therefore, there is a need to reduce energy waste while simultaneous be able to save the progress of work performed.

### SUMMARY

It is an objective of the present disclosure to provide a computing system and a method thereof having an UEFI Shell that can support a power saving mode.

According to one aspect of the invention, a method of computer processor execution of UEFI Shell in a computer system for entering into a power saving mode is provided, wherein the UEFI Shell is located in a memory, and the memory is connected to the processor. When executed, the UEFI Shell performs the following: (S1) initiating a call to a power saving library; (S2) retrieving corresponding power configuration data; (S3) retrieving and storing hardware registers data to memory; and (S4) enabling system control interrupt, initiating flushing of CPU internal caches, and configuring power-saving control registers with the power configuration data.

According to another aspect of the invention, a method of computer processor execution of UEFI Shell in a computer system for recovery from a power saving mode is provided. When executed, the UEFI Shell performs the following: (R1) retrieving and restoring CPU registers data from memory to CPU registers; (R2) disabling system control interrupt processes; (R3) retrieving and restoring hardware registers data from memory; (R4) initiating flushing of CPU internal caches; and (R5) executing reconnection of hardware controllers.

According to another aspect of the invention, a computer system having a memory storing an UEFI Shell supporting the computer system entering into a power saving mode is provided. When executed, the UEFI Shell performs the following: (S1) initiating a call to a power saving library; (S2) retrieving corresponding power configuration data; (S3) retrieving and storing hardware registers data to memory; and (S4) enabling system control interrupt, initiating flushing of CPU internal caches, and configuring power-saving control registers with the power configuration data.

According to another aspect of the invention, a computer system having a memory storing an UEFI Shell supporting the computer system recovering from a power saving mode is provided. When executed, the UEFI firmware performs the following: (R1) retrieving and restoring CPU registers data from memory to CPU registers; (R2) disabling system control interrupt processes; (R3) retrieving and restoring hardware registers data from memory; (R4) initiating flushing of CPU internal caches; and (R5) executing reconnection of hardware controllers.

### BRIEF DESCRIPTION OF THE DRAWINGS

FIG. 1 is a view of an embodiment of the computer system;

FIG. 2 is a view of an UEFI specification-compliant system;

FIG. 3 is a view of the different phases during execution of an UEFI firmware;

FIG. 4A is a flowchart of an embodiment of the method of entering a power saving mode of the present invention;

FIG. 4B is another embodiment of the flowchart in FIG.4A;

FIG. 5 is a flowchart of another method of FIG.4;

FIG. 6 is a view of an embodiment of the order in which standard PCI registers should be saved and/or restored in reverse order;

FIG. 7 is a view of an embodiment of the method of recovery from the power saving mode of the present invention; and

FIG. 8 is a view of another method of FIG.7.

### DETAILED DESCRIPTION OF THE PREFERRED EMBODIMENT

Embodiments of the present invention provide methods and systems for executing an UEFI firmware capable of supporting a power saving mode. In the following detailed description, references are made to the accompanying drawings that form a part hereof, and in which are shown by way of illustration specific embodiments or examples. These embodiments are only illustrative of the scope of the present invention, and should not be construed as a restriction on the present invention. Referring now the drawings, in which like numerals represent like elements through the several figures, aspects of the present invention and the exemplary operating environment will be described.

The present disclosure provides a computer system and method thereof for execution of UEFI firmware supporting entering into and recovery from a power saving mode. Preferably, the computer system includes (but not limited to) laptop computers, personal computers, computer servers, handheld computing devices such as mobile telephones and tablet computers, as well as wearable computing devices. It should be noted that in the present embodiment, the term UEFI firmware generally relates to the programming that is executed before the bootloader file is executed. This firmware may be embedded within an UEFI BIOS or may be separate from the UEFI BIOS. For instance, in the present embodiment, the UEFI firmware refers to an UEFI Shell that can be run upon power up of the computer system.

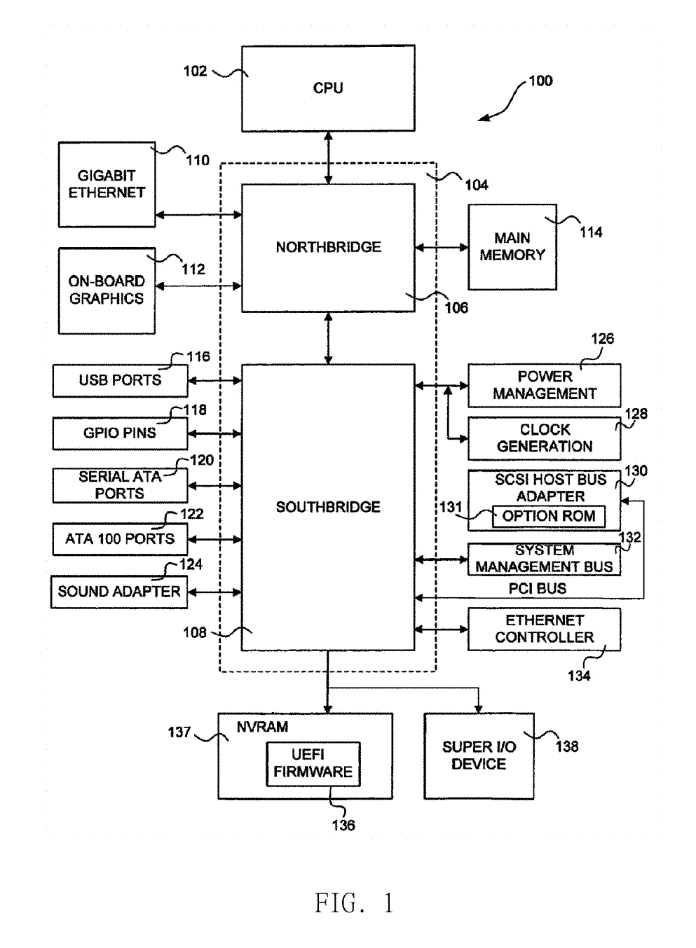

FIG. 1 and the following discussion are intended to provide a brief, general description of a suitable computing environment in which the invention may be implemented. However, those skilled in the art will recognize that the invention may also be implemented in other suitable computing environments. Moreover, those skilled in the art will appreciate that the invention may also be practiced with other computer system configurations, including multiprocessor systems, microprocessor-based or programmable consumer electronics, minicomputers, mainframe computers, and the like. The invention may also be practiced in distributed computing environments where tasks are performed by remote processing devices that are linked through a communications network.

Referring to FIG. 1, an illustrative computer architecture for practicing the embodiments discussed herein will be described. It should be appreciated that although the embodiments described herein are discussed in the context of a conventional desktop or server computer, the embodiments may be utilized with virtually any type of computing device. FIG. 1 shows an illustrative computer architecture for a computer system 100 that is operative to initiate an operating system boot from firmware. The blocks of FIG. 1 are intended to represent functional components of the computer architecture and are not intended to necessarily represent individual physical components. Functional components described may be combined, separated, or removed without departing from the overall sense and purpose of the computer architecture.

In order to provide the functionality described herein, the computer system 100 includes a baseboard, or “motherboard”, which is a printed circuit board to which a multitude of components or devices may be connected by way of a system bus or other communication path. In one illustrative embodiment, a central processing unit (CPU) 102 operates in conjunction with a chipset 104. The CPU 102 may be a standard central processor that performs arithmetic and logical operations necessary for the operation of the computer. The CPU 102, in this and other embodiments, may include one or more of a microprocessor, a microcontroller, a field programmable gate array (FPGA), a complex programmable logic device (CPLD), an application specific integrated circuit (ASIC), and/or any other electronic computing device.

The chipset 104 includes a northbridge 106 and a southbridge 108. The northbridge 106 provides an interface between the CPU 102 and the remainder of the computer system 100. The northbridge 106 also provides an interface to one or more random access memories (RAM) used as a main memory 114 in the computer system 100 and, possibly, to an on-board graphics adapter 112. The northbridge 106 may also enable networking functionality through a gigabit Ethernet adapter 110. The gigabit Ethernet adapter 110 is capable of connecting the computer system 100 to one or more other computers via a network. Connections that may be made by the adapter 110 may include local area network (LAN) or wide area network (WAN) connections, for example. LAN and WAN networking environments are commonplace in offices, enterprise-wide computer networks, intranets, and on the Internet. The northbridge 106 is connected to the southbridge 108.

The southbridge 108 is responsible for controlling many of the input/output functions of the computer system 100. In particular, the southbridge 108 may provide one or more universal serial bus (USB) ports 116, a sound adapter 124, an Ethernet controller 134, and one or more general purpose input/output (GPIO) pins 118. The southbridge 108 may also provide a bus for interfacing peripheral card devices such as a BIOS boot specification (BBS) compliant SCSI host bus adapter 130. In one embodiment, the bus comprises a peripheral component interconnect (PCI) bus. The southbridge 108 may also provide a system management bus 132 for use in managing the various components of computer system 100. Power management circuitry 126 and clock generation circuitry 128 may also be utilized during operation of the southbridge 108.

The southbridge 108 is also operative to provide one or more interfaces for connecting mass storage devices to the computer system 100. For instance, according to an embodiment, the southbridge 108 includes a serial advanced technology attachment (SATA) adapter for providing one or more serial ATA ports 120 and an ATA100 adapter for providing one or more ATA100 ports 122. The serial ATA ports 120 and the ATA100 ports 122 may be, in turn, connected to one or more mass storage devices storing an operating system, application programs, and other data. As known to those skilled in the art, an operating system comprises a set of programs that control operations of a computer and allocation of resources. An application program is software that runs on top of the operating system software, or other runtime environment, and uses computer resources to perform application specific tasks desired by a user of the computer system 100.

The mass storage devices connected to the southbridge 108 and the SCSI host bus adapter 130, and their associated computer-readable media, provide non-volatile storage for the computer system 100. Although the description of computer-readable media contained herein refers to a mass storage device, such as a hard disk or CD-ROM drive, it should be appreciated by those skilled in the art that computer-readable media can be any available media that can be accessed by the computer system 100. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, HD-DVD, BLU-RAY, or other optical storage, magnetic cassettes, magnetic tape, magnetic disk storage or other magnetic storage devices, or any other medium which can be used to store the desired information and which can be accessed by the computer.

A low pin count (LPC) interface may also be provided by the southbridge 108 for connecting a Super I/O device 138. The Super I/O device 138 is responsible for providing a number of input/output ports, including a keyboard port, a mouse port, a serial interface, a parallel port, and other types of input/output ports. The LPC interface or another interface may be utilized to connect a computer storage medium such as a ROM or a non-volatile random access memory (NVRAM) 137 such as a flash memory. The computer storage medium may be used for storing the firmware 136 that includes modules containing instructions and data that help to startup the computer system 100 and to transfer information between elements within the computer system 100. However, in other different embodiments, the firmware 136 may be stored in any other areas in the computer system 100.

The firmware 136 may include program code that is compatible with the UEFI specification. It should be appreciated that in addition to the firmware 136 including an UEFI compliant Shell, other types and combinations of firmware may be included. For instance, the firmware 136 may include additionally or alternatively a BIOS firmware and/or other type of firmware known to those in the art. Additional details regarding the operation of the UEFI firmware 136 are provided below with respect to the subsequent diagrams. It should be appreciated that the computer system 100 may not include all of the components shown in FIG. 1, may include other components that are not explicitly shown in FIG. 1, or may utilize an architecture completely different than that shown in FIG. 1.

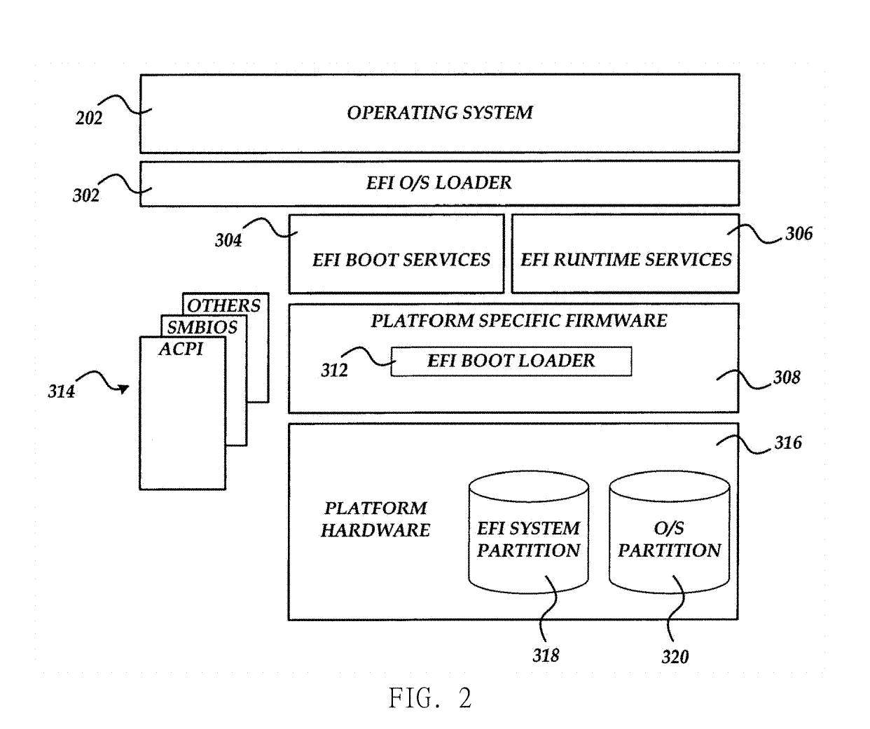

Referring to FIG.2, additional details regarding an UEFI specification-compliant system that may be utilized to provide an operating environment for the various implementations presented herein will be described. As shown in FIG. 2, the system may include a platform hardware 316 and an operating system (OS) 202. A platform firmware 308 may retrieve OS program code from the EFI system partition 318 using an OS loader 302, sometimes referred to as a boot loader or an OS boot loader. Likewise, the OS loader 302 may retrieve OS program code from other locations, including from attached peripherals or from the firmware 136 itself. The EFI system partition 318 may be an architecturally shareable system partition. As such, the EFI system partition 318 defines a partition and file system that are designed to allow safe sharing of mass storage between multiple vendors. An OS partition 320 may also be utilized.

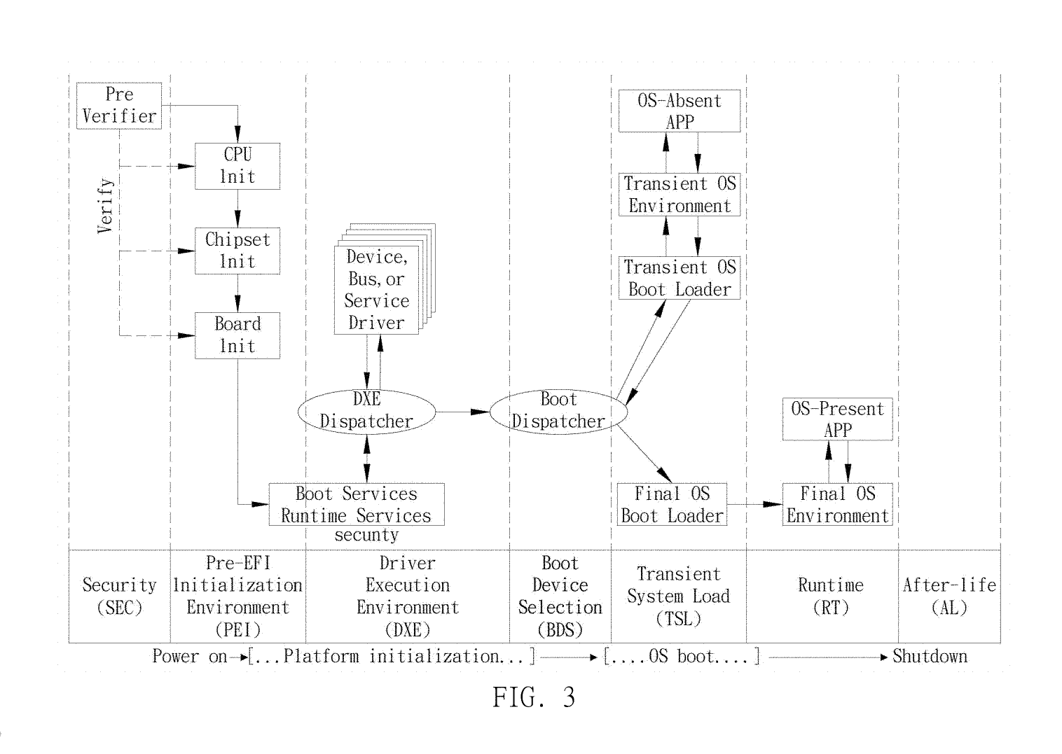

Referring to FIG. 3, details are shown to illustrate the different phases in the boot up of an exemplary computer system by a UEFI firmware. As shown in FIG. 3, in one embodiment, when the computer system 100 is powered on, the UEFI firmware of the present invention is executed by the processor of the computer system 100. The UEFI firmware will first enter a Security (SEC) phase, wherein no memory has yet been initialized in the computer system 100. In the present phase, since no memory has yet been initialized, the processor's cache is used as a Random Access Memory (RAM) to pre-verify the central processing unit (CPU), the chipset, and the main board. Next, the UEFI firmware enters the Pre-EFI Initialization (PEI) phase, wherein the CPU, the chipset, the main board, and the memory of the computer system 100 are initialized. In the Driver Execution (DXE) phase, boot services, runtime services, and driver execution dispatcher services may be executed to initialize any other hardware in the computer system 100. Following the DXE phase, the UEFI firmware enters into the Boot Device Selection (BDS) phase. In the BDS phase, attempts are made to initialize console devices as well as various drivers corresponding to the boot loader for the Operating System. In the Transient System Load (TSL) phase, control is handed off to the Operating System to continue the start up of the computer system 100 before reaching the Runtime (RT) phase of normal operation of the computer system 100.

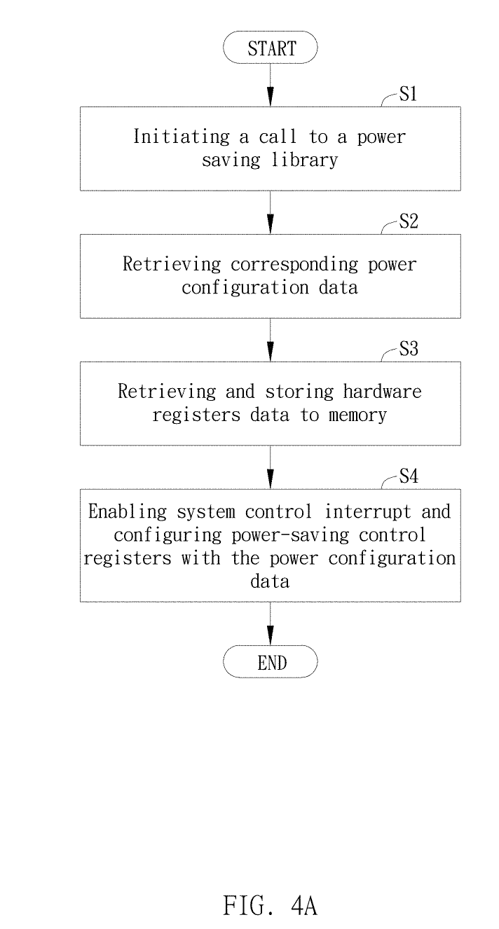

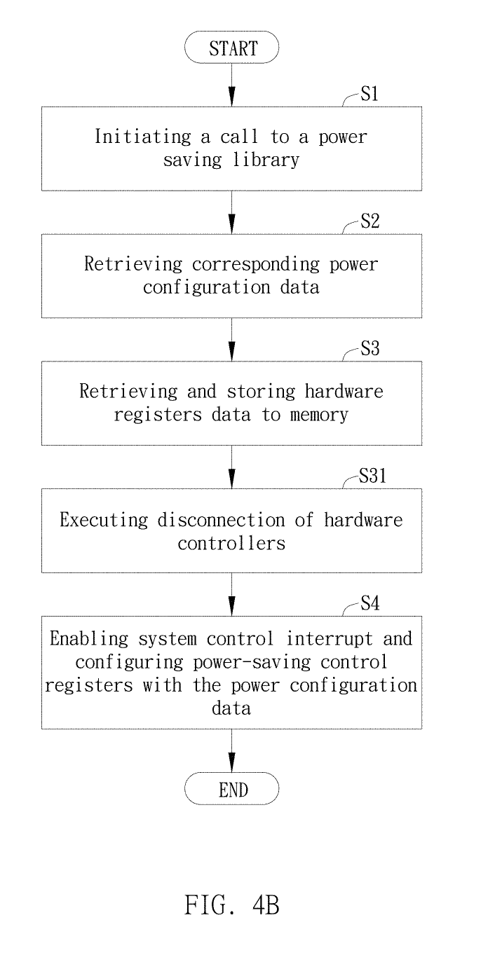

FIG. 4 illustrates an aspect of an embodiment of the present invention. As noted previously, the UEFI firmware may include an UEFI Shell, wherein the UEFI Shell can subsequently provide the ability to run UEFI applications, such as diagnostic applications. In other different embodiments, the UEFI Shell can be separate from the UEFI firmware that is responsible for initiating the UEFI OS loaders or bootloaders.

As shown in FIG. 4, a flowchart of a method of enabling a computer system to enter into a power saving mode via the UEFI Shell of the computer system is provided. In other words, the UEFI Shell is capable of entering into the power saving mode such that any and all UEFI applications executed under the UEFI Shell would correspondingly enter into the power saving mode as well. In the present embodiment, the power saving mode can be initiated by the UEFI Shell in any stage of the boot up prior to handing off control to the Operating System. In one embodiment, the UEFI Shell enters into the power saving mode after receiving an instruction to into the power saving mode. For instance, diagnostic engineers or users may enter a command to instruct the UEFI Shell to proceed into the power saving mode. In other different embodiments, once the computer system is powered on and executes the UEFI Shell, the UEFI Shell can automatically enter into the power saving mode after inactivity from the user according to a default idle time.

As shown in FIG. 4, the method of entering into the power saving mode includes steps S1 to S4, wherein these steps will be described in more detail below.

Step S1 includes initiating a call to a power saving library. In the present embodiment, the power saving mode refers to the S3 sleep stage corresponding to the Advanced Configuration and Power Interface (ACPI) Standard; however, in other different embodiments, the power saving mode may refer to any other state of the ACPI standard that is capable of conserving energy or correspond to any other standards for conserving energy. Correspondingly, when the power saving mode refers to the S3 state of the ACPI standard, the power saving library referred to in step S1 is directed to the procedure/process detailed for sleep or standby state of Suspend-to-Ram (STR). Normally, the ACPI standard is implemented by the Operating System and the applications running on the Operating System. However, via the present invention, the UEFI Shell is capable of performing this task without the Operating System as long as applications running on the UEFI Shell are ACPI compliant (ie. applications run with Shell S3 library). It should be noted that in other different embodiments, the power saving mode can refer to any of the other two sleep states (S1 or S2), or hibernate state (S4).

Step S2 includes retrieving corresponding power configuration data. In the present embodiment, UEFI applications run with ACPI compliant Shell S3 library will have their corresponding power configuration data recorded in their ACPI tables. For instance, the power configuration data may include the FACP table describing the Input/Output port location(s) for kernel ACPI implementation, Differentiated System Description Table (DSDT) containing a bytecode that is executed by a driver in the kernel, or any of the other tables in the ACPI standard. At this instance, the power configuration data is temporarily stored for further use right before entering the power saving mode.

Step S3 includes retrieving and storing hardware registers data to memory. In the present embodiment, the memory refers to the RAM (random access memory) of the computer system. However, the present invention is not limited to RAM memory; in other different embodiments, other types of memory may be utilized. For instance, for implementation of S4 sleeping mode, system context can be saved to a back-up media such as a hard disk drive. In the present embodiment, the hardware registers data refers to the data stored in the registers pertaining to the hardware of the computer system. In other words, the purpose of step S3 is to get a snap shot of the state of the registers before entering into the power saving mode.

Step S4 includes enabling system control interrupt, initiating flushing of CPU internal caches, and then configuring power-saving control registers with the power configuration data. In the present embodiment, the system control interrupt (SCI) is enabled such that any ACPI compliant applications running under the UEFI Shell of the present invention can be aware of the event and perform any subsequent processes to prepare for entering the power saving mode. Prior to entering the power saving mode, a wake-up event must be enable before entering the power saving mode. For instance, with the values of \_S3 object in the power configuration data, the SLP_TYP and SLP_EN sleep registers of the PM1 control registers (for fixed features or hardware devices) may be configured or set such that the computer system can enter into and recover (wake) from the power saving mode according to the S3 sleep state of the ACPI standard. At this point, the computer system then enters the power saving mode.

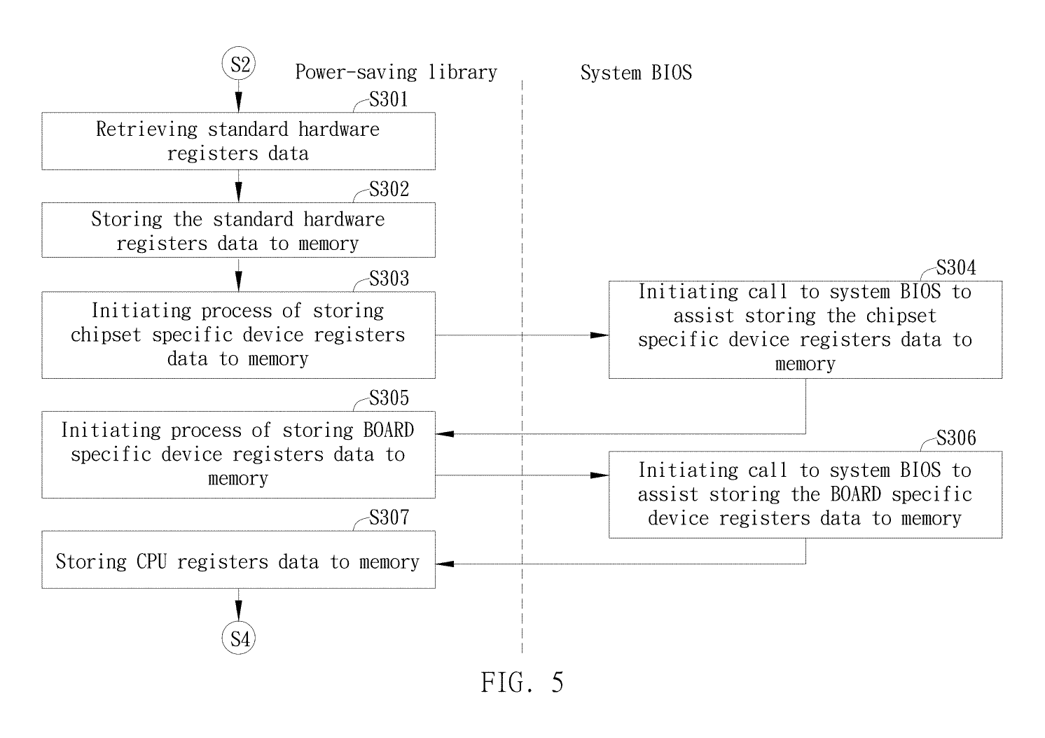

FIG. 5 is another embodiment of step S3 of FIG. 4 of retrieving and storing hardware registers data to memory. In the present embodiment, step S3 can further include steps S301 to S307, wherein these steps are further described in detail below.

Step S301 includes retrieving standard hardware registers data, wherein step S302 then includes saving these registers data to memory (ex. RAM). In the present embodiment, steps S301 and S302 can save to memory (RAM), in order, the 8259 Programmable Interrupt Controller (PIC) data, High Precision Event Timer (HPET) data, Peripheral Component Interconnect (PCI) and Peripheral Component Interconnect Express (PCI-e) data, Input/Output Advanced Programmable Interrupt Controller (I/O APIC) data, and local APIC data.

In an embodiment of the present invention, steps S303 to S307 are preferably done in order; however, in other different embodiments, the order can be adjusted to suit requirements.

Step S303 includes initiating process of storing or saving chipset specific device registers data to memory. In the present embodiment, the chipset specific device registers of the computer system is retrieved and saved to memory. It should be noted that up until now, the UEFI shell S3 library has been executing these steps. In the event assistance is needed in saving the chipset specific device registers to memory, step S304 of initiating call to system BIOS to assist storing/saving of the chipset specific device registers to memory may be executed. For instance, PM control registers may be saved to memory via a call to system BIOS. After step S304, the process returns back to the UEFI shell S3 library.

Steps S305 and S306 follow a similar pattern to steps S303 to S304, wherein instead of retrieving and saving the chipset specific device registers data to memory, steps S305 and S306 retrieves and saves BOARD specific device registers data to memory. In the event that assistance is needed to save the board specific device registers data to memory, the UEFI shell S3 library can initiate a call to system BIOS to help save some board specific registers data to memory.

In step S307, the process returns back to the UEFI shell S3 library, wherein the CPU registers data is saved to memory.

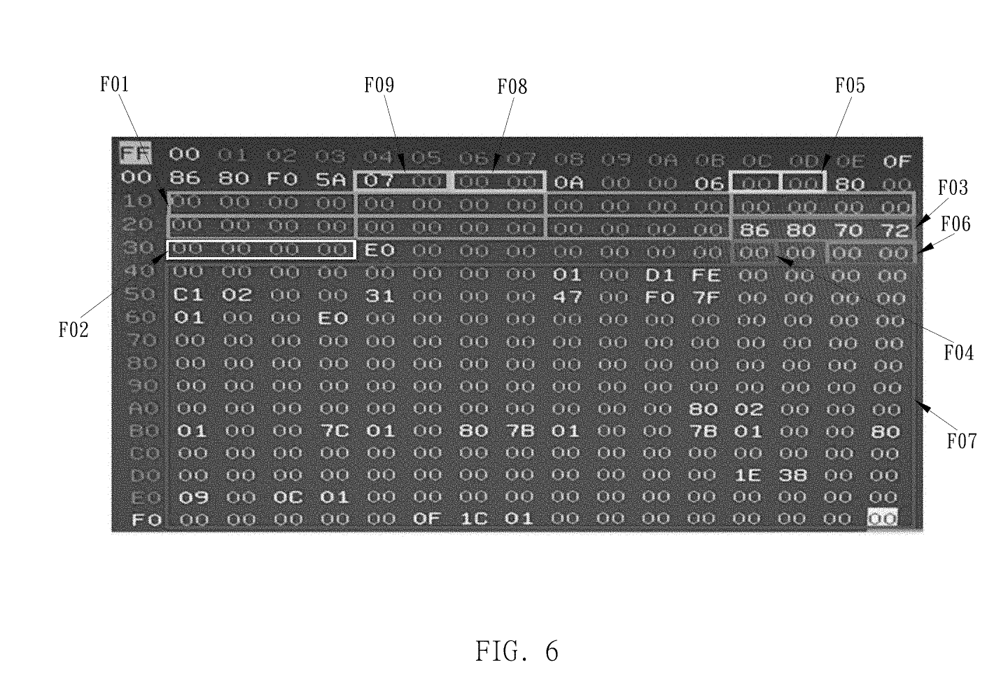

FIG. 6 is an embodiment of the memory where steps S301-S307 saves the data in order (in the order of F01 to F09). It should be noted that the size and location that each data is saved into memory is not limited to this embodiment; in other different embodiments, the order, size, and location can be adjusted according to requirements.

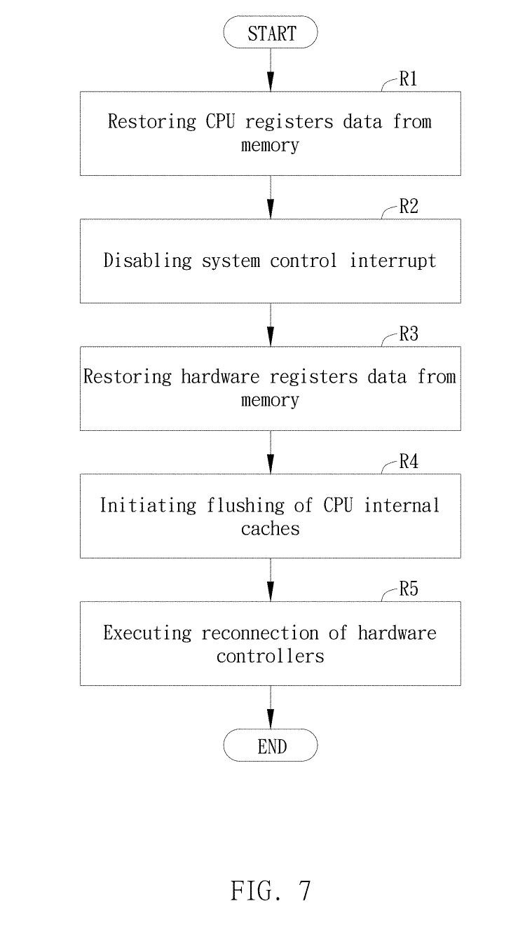

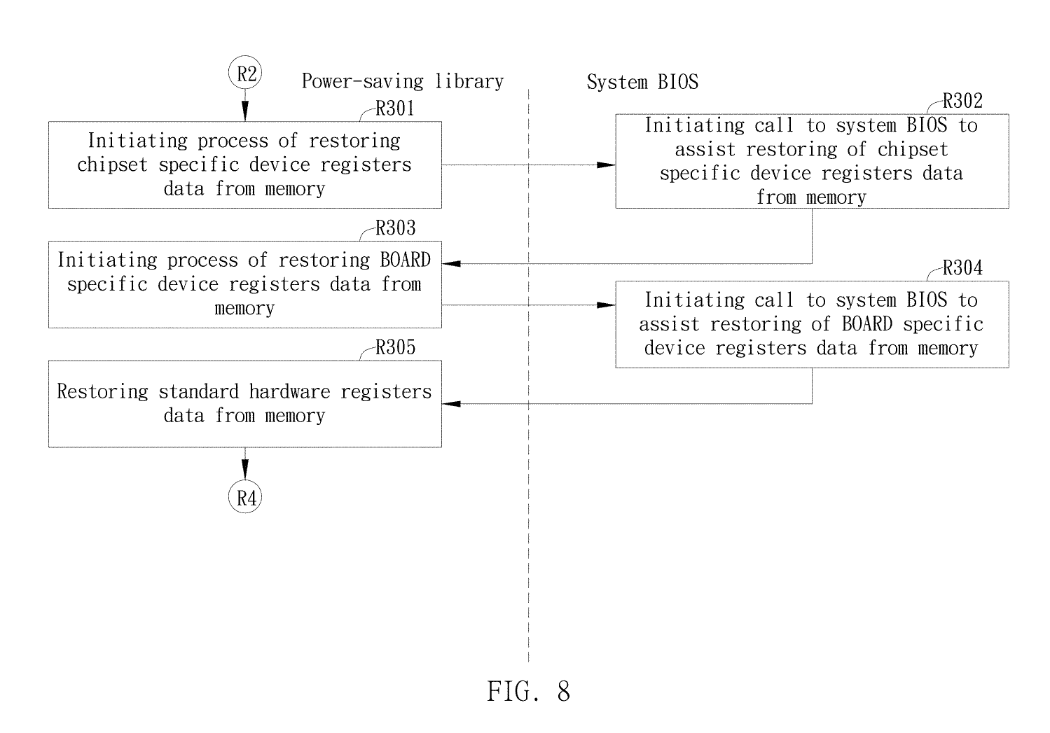

FIGS. 7 and 8 illustrate embodiments recovering or waking from the power saving mode, wherein the method includes steps R1 to R5. Preferably, before actually starting the procedure of waking up, a step of validating whether the computer system is in the power saving mode is performed.

Step R1 includes retrieving and restoring CPU registers data from memory to CPU registers. In the present embodiment, this step starts with assembly code, and may include initialization of the Global Descriptor Table (GDT) and Interrupt Vector Table (IDT), enabling of Paging64 mode if the computer system is an x64 build, and then restoring of standard CPU registers with the CPU registers data from memory.

Step R2 includes disabling system control interrupt (SCI). In the present embodiment, the ACPI system control interrupt can be disabled via the Trigger function of the UEFI system management mode (SMM) Control protocol to issue ACPI disable S/W system management interrupt (SMI) or directly write zero to bit 0 of ACPI PM1 control register.

Step R3 includes retrieving and restoring hardware registers data from memory. In the present embodiment, with respect to FIG. 6, step R3 restores the hardware registers data in the reverse order to how they are saved to memory. However, in other different embodiments, the order in which the hardware registers data is restored can be adjusted according to requirements.

Step R4 includes initiating flushing of CPU internal caches. In the present embodiment, a call to WBINVD (Write Back and Invalidate Cache) is executed to flush the internal cache of dirty lines of code that may be left there. This ensures that the computer system starts with a clean slate when waking up from the power saving mode. In other words, the flushing of the internal cache is to ensure that the original data that needs to be restored can indeed be restored and written back into their corresponding hardware devices.

Step R5 includes executing reconnection of hardware controllers. In the present embodiment, the hardware controllers are reconnected via the UEFI ConnectController Boot Service. Once all hardware controllers are reconnected, the computer system recovers from the power saving mode and back to the original UEFI shell application running before the computer system was placed in the power saving mode.

FIG. 8 illustrates another embodiment of step R3 of FIG. 7. In the present embodiment, steps R301-R305 restore hardware registers from memory.

Step R301 includes initiating process of restoring chipset specific device registers data from memory. In the event assistance is needed to perform this step, a call to the system BIOS may be executed in step R302 to assist in restoring of the chipset specific device registers data from memory. Thereafter, the process returns back to the UEFI Shell S3 library.

Step R303 includes initiating process of restoring BOARD specific device registers data from memory. Similarly, if necessary, step R304 of a call to system BIOS may be executed to assist in restoring some BOARD specific registers from memory.

Step R305 includes restoring/initializing standard hardware registers data from memory. In the present embodiment, this step is the reverse order of step S302, wherein the local APIC, I/O APIC, PCl/PCI-e, HPET, Timer (8254) initialization, and PIC (8259) are done in order.

Although the embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A method of computer processor execution of an UEFI shell in a computer system for entering into a power saving mode, the UEFI shell located in a memory, the memory is connected to the processor, the method comprising:
executing, by the processor, the UEFI shell;
when executing the UEFI shell:
(S1) initiating a call to a power saving library;
(S2) retrieving corresponding power configuration data;
(S3) retrieving and storing hardware registers data to memory; and
(S4) enabling system control interrupt, initiating flushing of CPU internal caches, and configuring power-saving control registers with the power configuration data.

2. The method of claim 1, wherein before the step of initiating the call to the power saving library, further comprising:
executing an application running with the power saving library, wherein the power saving library is a Shell S3 library corresponding to the Advanced Configuration and Power Interface (ACPI) Standard.

3. The method of claim 1, wherein the step of retrieving corresponding power configuration data further comprising:
retrieving relative Advanced Configuration and Power Interface (ACPI) data via standard ACPI tables and storing into an S3 data object.

4. The method of claim 1, wherein the step of retrieving and storing hardware registers data to memory further comprising:
storing 8259 Programmable Interrupt Controller (PIC) data to memory;
storing High Precision Event Timer (HPET) data to memory;
storing Peripheral Component Interconnect (PCI) and Peripheral Component Interconnect Express (PCI-e) data to memory;
storing Input/Output Advanced Programmable Interrupt Controller (I/O APIC) data to memory; and
storing local APIC data to memory.

5. The method of claim 1, wherein the step of retrieving and storing hardware registers data to memory further comprising:
Retrieving chipset specific device registers data from the computer system and storing to memory.

6. The method of claim 5, further comprising:
Via system call to system BIOS, enabling system BIOS to assist in the storing of the chipset specific device register data to memory.

7. The method of claim 1, wherein the step of retrieving and storing hardware registers data to memory further comprising:
Retrieving board specific device registers data from the computer system and storing to memory.

8. The method of claim 7, further comprising:
via system call to system BIOS, enabling system BIOS to assist in the storing of the board specific device registers data to memory.

9. The method of claim 1, wherein the step of retrieving and storing hardware registers data to memory further comprising:
retrieving and storing central processing unit (CPU) registers data to memory.

10. A method of computer processor execution of an UEFI shell in a computer system for recovering from a power saving mode, wherein the UEFI shell is located in a memory, the memory is connected to the processor, the method comprising:
executing, by the processor, the UEFI shell;
when executing the UEFI shell:
(R1) retrieving and restoring CPU registers data from memory to CPU registers;
(R2) disabling system control interrupt;
(R3) retrieving and restoring hardware registers data from memory;
(R4) initiating flushing of CPU internal caches; and
(R5) executing reconnection of hardware controllers.

11. The method of claim 10, wherein the step of retrieving and restoring CPU registers data from memory to CPU registers further comprising:
validating the computer system is in a power saving mode and is set for recovery from the power saving mode.

12. The method of claim 10, wherein the step of retrieving and restoring CPU registers data from memory to CPU registers further comprising:
initializing at least one of Global Descriptor Table (GDT) and Interrupt Vector Table (IDT);
enabling Paging64 mode if the computer system is an x64 build; and
restoring standard CPU registers with the CPU registers data from memory.

13. The method of claim 10, wherein the step of restoring hardware registers data from memory further comprising:
initiating process of restoring chipset specific device registers data from memory.

14. The method of claim 13, further comprising:
initiating system call to system BIOS to assist restoring of chipset specific device registers data from memory.

15. The method of claim 10, wherein the step of restoring hardware registers data from memory further comprising:
initiating process of restoring board specific device registers data from memory

16. The method of claim 15, further comprising:
initiating system call to system BIOS to assist restoring of board specific device registers data from memory.

17. The method of claim 10, wherein the step of restoring hardware registers data from memory further comprising:
restoring standard hardware registers data from memory to the computer system.

18. The method of claim 17, further comprising:
restoring local Advanced Programmable Interrupt Controller (APIC) from memory;
restoring Input/Output Advanced Programmable Interrupt Controller (I/O APIC) data from memory;
restoring Peripheral Component Interconnect (PCI) and Peripheral Component Interconnect Express (PCI-e) data from memory;
restoring High Precision Event Timer (HPET) data from memory;
initializing 8254 Programmable Interval Timer of the computer system; and
restoring 8259 Programmable Interrupt Controller (PIC) data to the computer system from memory.

19. A Computer System comprising:
a memory storing an UEFI shell for supporting UEFI applications in the computer system to enter into a power saving mode; and
a processor operatively coupled to the memory and executing the UEFI firmware;
wherein executing the UEFI firmware performs the steps of:
(S1) initiating a call to a power saving library;
(S2) retrieving corresponding power configuration data;
(S3) retrieving and storing hardware registers data to memory; and
(S4) enabling system control interrupt, initiating flushing of CPU internal caches, and configuring power-saving control registers with the power configuration data.

20. A Computer System comprising:
a memory storing an UEFI shell for supporting UEFI applications in the computer system to recover from a power saving mode; and
a processor connected to the memory and executing the UEFI shell;
wherein executing the UEFI shell performs the steps of:
(R1) retrieving and restoring CPU registers data from memory to CPU registers;
(R2) disabling system control interrupt processes;
(R3) retrieving and restoring hardware registers data from memory;
(R4) initiating flushing of CPU internal caches; and
(R5) executing reconnection of hardware controllers.
